(19) United States
(12) Patent Application Publication
(10) Pub. No.: US 2007/0049152 A1
(43) Pub. Date: Mar. 1, 2007

(54) Panel containing bamboo

(76) Inventor: Nian-hua Ou, Dacula, GA (US)

Correspondence Address: Carlos Nieves, Esq.;J.M. Huber Corporation, 333 Thornall Street, Edison, NJ, 08837-2220, US

(21) Appl. No.: 11/216,654

(22) Filed: Aug. 31, 2005

(51) Int. Cl. B32B 21/04

(52) U.S. Cl. 442/295; 442/185; 442/186; 442/239; 442/301; 144/333

(57) ABSTRACT

Disclosed is a wood panel comprising: a composite wood component having upper and lower surface layers and a core layer; and one or more bamboo layers, the one or more bamboo layers having a thickness of about about 0.0625 inches to about 0.5, attached to the upper surface layer of the wood composite.

### TITLE OF THE INVENTION

Panel Containing Bamboo

### BACKGROUND OF THE INVENTION

Bamboo is a lignocellulosic material widely used throughout Asia as a structural material because of its high strength, durability and excellent dimensional stability. Given its widespread use and excellent performance, there is an existing desire to make structural panels out of bamboo.

Presently, such bamboo structural panels are made by hand-cutting bamboo strips from the outer part or surface of a bamboo culm, and then weaving (again typically by hand) into mats. These hand-cut, hand-woven bamboo mats are then stacked together along with several other similar mats and the mats then pressed together under high temperature.

The problem with this method of manufacture of the bamboo boards is that it is time consuming; the steps of cutting the bamboo strips and then weaving the bamboo strips into the form of a mat take a significant amount of time. And not only are these processes time consuming, but they can lead to significant defects in the final board product. For example, internal gaps created by the layering of several of the mats on top of another can result in the production of holes or other defects in the board that can lead to failure. Additionally, bonding two woven bamboo mats together involves bonding together two mating surfaces, which is an additional source for defects. Yet another disadvantage of the aforementioned processes is that because they are composed of large numbers of bamboo layers, they are require very high doses of resin per layer, which adds greatly to the price of the product during periods of high petroleum prices.

Given the foregoing there is a need in the art for structural bamboo panels that have fewer defects, do not require a lengthy manufacturing process, and consume a smaller amount of petroleum-based products.

### BRIEF SUMMARY OF THE INVENTION

The present invention includes a wood panel comprising: a composite wood component having upper and lower surface layers and a core layer; and one or more bamboo layers, the one or more bamboo layers having a thickness of about about 0.0625 inches to about 0.5, attached to the upper surface layer of the wood composite.

### DETAILED DESCRIPTION OF THE INVENTION

All parts, percentages, and ratios used herein are expressed by weight unless otherwise specified. All documents cited herein are incorporated by reference.

As used herein, “lignocellulosic material” is intended to mean a cellular structure, having cell walls composed of cellulose and hemicellulose fibers bonded together by lignin polymer. Wood is a species of lignocellulosic material.

By “wood composite material” or “wood composite component” it is meant a composite r particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition, which is hereby incorporated by reference. The following describes preferred embodiments of the present invention, which provides a wood panel comprising a wood composite component and one or more bamboo layers. The wood composite material forms the interior of the panel, while the one or more bamboo layers are formed from woven sheets of bamboo. This allows the manufacture of wood panels, that have the tough, durable surface of bamboo without requiring a very large number of woven bamboo sheets—instead, a smaller number of woven bamboo sheets are affixed on to the wood composite core. This panel addresses the aforementioned drawbacks of structural bamboo panels: the panel has the durability of bamboo; specifically, it has the durability of bamboo but is without the internal surface gaps and other defects that can compromise performance. Additionally, reducing the number of bamboo sheets shortens the manufacturing process and results in a panel product that is a less intensive user of petroleum-based products.

Bamboo layers

Like other wood materials, bamboo's basic components are cellulose fibers bonded together by lignin polymer, but bamboo differs from other wood materials in the organization and morphology of its constituent cells. Generally, most strength characteristics of bamboo (tensile strength, flexural strength and rigidity) are greatest in the longitudinal direction of the bamboo and the bamboo fibers. This is due to the relatively small micro-fibrillar angle of the cellulose fibers in the longitudinal direction. The hardness of the bamboo culm itself is dependent on the density of bamboo fibers bundles and their manner of separation. The percentage of fibers is not consistent either in the longitudinal direction of the bamboo culm or in a cross section of the culm. In the longitudinal direction, the density of fibers increases from the bottom of the culm to its top, while the density of fibers in the bamboo culm cross-section is highest closer to the outer surface and decreases going deeper into the core of the material. Moreover, the strength and hardness of the outer portion of the bamboo culm is increased by the presence of a silica-deposited, cutinized layer coated with wax, which covers the surface of the outer part of the culm. Thus, the bamboo on or near the outer surface of the culm has superior strength characteristics, and in most processes for using bamboo. Unlike previous techniques for using bamboo wood in which the cutinized layer is stripped off and thus the strongest part of the culm discarded, in the present invention the cutinized layer is used and thus the high strength properties of the bamboo are maintained.

Overall, the cellulose fibers in bamboo are stiffer and stronger than the fibers of most wood species, so that boards incorporating bamboo could have a much higher strength to weight ratio than boards made from other types of wood fibers.

As used in the present invention the bamboo is formed into woven bamboo sheets. These sheets are formed by first cutting strips of bamboo either: (1) the entire length of the bamboo trunk (a distance typically between 4 to 40 feet) or (2) into shorter pieces. This cutting may be done either manually or with mechanized clipping equipment. The strips are woven together manually to form woven bamboo sheets. The sheets are then coated with an isocyanate resin. Preferably the isocyanates are selected from the diphenylmethane-p,p′-diisocyanate group of polymers, which have NCO- functional groups that can react with other organic groups to form polymer groups such as polyurea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is Rubinate 1840 available from Huntsman, Salt Lake City, Utah, and Mondur 541 available from Bayer Corporation, North America, of Pittsburgh, Pa. Also suitable for use are phenol formaldehyde (“PF”), melamine formaldehyde, melamine urea formaldehyde (“MUF”) and the co-polymers thereof. Suitable commercial MUF binders are the LS 2358 and LS 2250 products from the Dynea corporation.

The resin concentration will be from about 2 wt % to about 12 wt %, based on the dry weight of the bamboo sheet. After being coated with the resin, the bamboo sheets may optionally be allowed to dry. (Typically, drying is not necessary only isocyanate resins are being used). The drying can be done at ambient temperature or using a kiln, although if a kiln is used, it must be set to a low temperature that does not initiate cure of the resin. The sheets are used either singly or in combination with other bamboo sheets to form one or more bamboo layers placed on top of a composite wood piece, as is described in greater detail below with respect to the primary and secondary process of manufacture.

The panels will vary in thickness from 0.25 inch thick to 2.0 inch thick and have panel dimensions of 4 feet by 8 feet. The thinnest panels could be used web stock for engineered wood I-joists. The panels of intermediate thickness could be used as sheathing and sub flooring. The thickest panels used for millwork applications. Another use for the products could be as shipping containers and decking material for transportation trailers.

Wood Composite Component

Preferably, the wood composite component is made from OSB material. The oriented strand board is derived from a starting material that is naturally occurring hard or soft woods, singularly or mixed, whether such wood is dry (having a moisture content of between 2 wt % and 12 wt %) or green (having a moisture content of between 30 wt % and 200 wt %). Typically, the raw wood starting materials, either virgin or reclaimed, are cut into strands, wafers or flakes of desired size and shape, which are well known to one of ordinary skill in the art.

After the strands are cut they are dried in an oven and then coated with a special formulation of one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, a preferred technique is to spray the wax, resin and other additives upon the wood strands as the strands are tumbled in a drum blender.

After being coated and treated with the desired coating and treatment chemicals, these coated strands are used to form a multi-layered mat, preferably a three layered mat. This layering may be done in the following fashion. The coated flakes are spread on a conveyor belt to provide a first ply or layer having flakes oriented substantially in line, or parallel, to the conveyor belt, then a second ply is deposited on the first ply, with the flakes of the second ply oriented substantially perpendicular to the conveyor belt. Finally, a third ply having flakes oriented substantially in line with the conveyor belt, similar to the first ply, is deposited on the second ply such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. In the case of a three ply or three layered mat, the first and third plys are surface layers, while the second ply is a core layer. The surface layers each have an exterior face.

The above example may also be done in different relative directions, so that the first ply has flakes oriented substantially perpendicular to conveyor belt, then a second ply is deposited on the first ply, with the flakes of the second ply oriented substantially parallel to the conveyor belt. Finally, a third ply having flakes oriented substantially perpendicular with the conveyor belt, similar to the first ply, is deposited on the second ply.

Various polymeric resins, preferably thermosetting resins, may be employed as binders for the wood flakes or strands. Suitable polymeric binders include isocyanate resin, urea-formaldehyde, polyvinyl acetate (“PVA”), phenol formaldehyde, melamine formaldehyde, melamine urea formaldehyde (“MUF”) and the co-polymers thereof. Isocyanates are the preferred binders, and preferably the isocyanates are selected from the diphenylmethane-p,p′-diisocyanate group of polymers, which have NCO- functional groups that can react with other organic groups to form polymer groups such as polyurea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is Rubinate 1840 available from Huntsman, Salt Lake City, Utah, and Mondur 541 available from Bayer Corporation, North America, of Pittsburgh, Pa. Suitable commercial MUF binders are the LS 2358 and LS 2250 products from the Dynea corporation.

The binder concentration is preferably in the range of about 2 wt % to about 15 wt %. A wax additive is commonly employed to enhance the resistance of the OSB panels to moisture penetration. Preferred waxes are slack wax or an emulsion wax. The wax solids loading level is preferably in the range of about 0.1 wt % to about 3.0 wt % (based on the weight of the wood).

After the multi-layered mats are formed according to the process discussed above, they are compressed under a hot press machine that fuses and binds together the wood materials, binder, and other additives to form consolidated OSB panels of various thickness and sizes. The high temperature also acts to cure the binder material. Preferably, the panels of the invention are pressed for 2-15 minutes at a temperature of about 175° C. to about 240° C. The resulting composite panels will have a density in the range of about 35 lbs/ft³ to about 48 lbs/ft³ (as measured by ASTM standard D1037-98). The density ranges from 40 lbs/ft³ to 48 lbs/ft for southern pine, and 35 lbs lbs/ft³ to 42 lbs/ft³ for Aspen. The thickness of the OSB panels will be from about 0.6 cm (about ¼″) to about 5 cm (about 2″), such as about 1.25 cm to about 6 cm, such as about 2.8 cm to about 3.8 cm.

Next, the final wood panel is produced using either a primary or secondary process. In the primary process, the one or more woven bamboo layers are placed onto the conveyor belt first before the coated flakes (see above), then the flakes are arranged on top of the woven bamboo layers, and then a second set of woven bamboo layers are placed on top of the flakes. This unconsolidated structure is then passed into a hot press and consolidated using heat and pressure with the resin coating on the flakes and the bamboo layers providing the adhesive bond. A primary process suitable for use in the present invention is described in U.S. Pat. No. 6,737,155.

As an alternative to the primary process, a secondary process could be used. In the secondary process, the wood composite component and the bamboo layers are attached to each other to form a composite panel. Such attachment occurs such as by adhesively bonding the bamboo layers to the exterior faces of the surface layers of the wood composite component, such as by lamination. This is done by placing woven bamboo layers on the conveyor, placing a wood composite panel on top of the woven bamboo layers so that the lower surface of the wood composite panel contacts the woven bamboo layers, and then placing additional woven bamboo layers on the upper surface of the wood composite panel. The resin coating on the woven bamboo sheets provides adhesive attachment between the woven bamboo sheets and the surface layers of the wood composite component. The conveyor then transfers this bamboo-wood composite-bamboo mat into a press where heat and pressure are applied to consolidate the layers into a single composite structure panel.

Additionally, the wood panels may also be present in yet another embodiment. In this embodiment, the wood panels include not one but two wood composite components. In this structure, there are successive alterations of bamboo layers, followed by the wood composite component, followed by the bamboo layers, followed by the wood composite component, followed by the bamboo layers. Regardless of which process or structure is chosen, the thickness of the bamboo layers will be from about 0.0625 inches to about 0.5 inches.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A wood panel comprising:
a composite wood component having upper and lower surface layers and a core layer; and
one or more bamboo layers, the one or more bamboo layers having a thickness of about about 0.0625 inches to about 0.5, attached to the upper surface layer of the wood composite.

2. The wood panel according to claim 1, comprising one or more bamboo layers attached to the lower surface layer of the composite wood component.

3. The wood panel according to claim 1, wherein the composite wood component is oriented strand board.

4. The wood panel according to claim 1, wherein the one or more bamboo layers are laminated to the upper surface layer of the composite wood component.

5. The wood panel according to claim 1, wherein the one or more bamboo layers are made from woven bamboo.

6. The wood panel according to claim 1, wherein the one or more bamboo layers are made from bamboo strips taken from the outer portion of a bamboo culm.

7. The wood panel according to claim 1, wherein the one or more bamboo layers include more than 3 layers.

8. A process for preparing a wood panel comprising the steps of:
providing a composite wood component, the wood component including an upper surface layer, the upper surface layer having an exterior face;
cutting bamboo strips from a bamboo culm;
weaving the bamboo strips into one or more bamboo mats; and
applying the one or more bamboo mats to the exterior face of the upper surface of the wood component.

9. The process for preparing a wood panel according to claim 8, wherein the bamboo strips are cut from the outer portion of the bamboo culm.
